(19) United States
(12) Patent Application Publication
(10) Pub. No.: US 2001/0037949 A1
(43) Pub. Date: Nov. 8, 2001

(54) Electrochemical sensor for real-time recording of environmental parameters

(76) Inventors: Martin J. Patko, Orange, CA (US); Michael H. Burnam, Hidden Hills, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/902,126

(22) Filed: Jul. 10, 2001

Related U.S. Application Data
(63) Continuation of application No. 09/135,877, filed on Aug. 17, 1998.

(51) Int. Cl. G01N 27/26

(52) U.S. Cl. 205/775; 204/416

(57) ABSTRACT

The present invention combines highly advanced electrochemical sensors with inexpensive microcircuitry and other optional sensing devices to produce an electrochemical sensor with microprocessor and memory capabilities. The sensor of the invention is small, self-powered, simple to use, and sufficiently inexpensive to be practical for use in recording environmental conditions to which low unit cost perishable products are exposed during shipping and/or storage.

### RELATED APPLICATIONS

This application is a continuation of U.S. application Ser. No. 09/135,877, filed on Aug. 17, 1998.

### FIELD OF THE INVENTION

The present invention relates to sensors capable of detecting and recording environmental parameters. More particularly, it relates to sensors that include a detector that functions both to detect chemical species and also to supply power to a data storage device and microprocessor on the sensor.

### BACKGROUND OF THE INVENTION

Advances in the field of electronics have impacted a wide variety of industries, often in unexpected ways. Microcircuitry devices in particular has become so small, inexpensive, and powerful, that they have revolutionized industries into which this technology expands.

The storage and shipping industries are concerned with, among other things, providing proper conditions for whatever product or cargo is being handled. For certain products it may be necessary to maintain a relatively constant temperature, while others may be sensitive to extremes of humidity or pressure, the presence of radiation, light, gases or vapors, and the like.

Employing prior art devices and methods, it has not been economically practical to carry out real-time measurement and storage of critical environmental data for quality assurance of most products. Certainly for very expensive products, a system for measuring the critical conditions may be both required and economically worthwhile. However, the relatively low unit price of most perishable products renders impractical the large expenditures that would be required to assure and verify high levels of quality control in shipping and storage conditions. This is aggravated by the fact that damage to products during storage or transport, caused by exposure to unfavorable environmental conditions, is not always evident on cursory inspection of the product by the recipient.

Thus, it would be desirable to provide an inexpensive and simple device for measuring and recording critical environmental parameters that may indicate whether a particular product has been exposed to damaging conditions during storage, shipping, or shelf life.

### SUMMARY OF THE INVENTION

The present invention provides a sensor for detecting and recording an environmental condition. The sensor may include: a first half cell containing a calibrant composition of a first ion species having a first ion concentration, and a first electrode in contact with the calibrant composition; a second half cell including a sensing composition of the first ion species having a second ion concentration, and a second electrode in contact with the sensing composition; an ion-selective membrane disposed between the first half cell and the second half cell; a conductive composition in contact with the first half cell and the second half cell so that an electrical potential may be formed across the ion selective membrane; and a data storage device and a microprocessor or microcontroller in data communication with the first electrode and the second electrode, wherein the electrical potential provides power to the data storage device and to the microprocessor or microcontroller.

The sensor of this aspect may include embodiments wherein the data storage device includes a volatile electronic memory device or a non-volatile electronic memory device. The volatile electronic memory device may be a dynamic random access memory (DRAM) or static random access memory (SRAM). The sensor may further include a third half cell including a second calibrant composition of a second ion species, and a third electrode in contact with the second calibrant composition. The first and/or second ion species in the sensor may be selected from the group consisting of: calcium, chloride, hydrogen, lithium, magnesium, potassium and sodium. The conductive composition of the sensor may include a layer of material adapted for insertion into a depression of the sensor to contact the first and second half cells to form the electrical potential across the membrane. The layer of material may be further adapted for removal from the depression, and may be a conductive gel adapted for absorbing a chemical species by diffusion. The sensor may include at least one additional detector, the additional detector also being in contact with the data storage device and the microprocessor or microcontroller. The additional detector may be adapted for detecting an environmental condition selected from the group consisting of: concentration of a chemical species, temperature, pressure, humidity, radiation, and light.

In another aspect of the present invention is provided a method of measuring and recording a concentration of a first chemical species over time, including: providing an electrochemical sensor including an ion detector and a data storage device, wherein the ion detector includes at least two half cells having an electrical potential therebetween, wherein the electrical potential may be indicative of a concentration of a second chemical species in at least one half cell, and wherein the electrical potential provides power to the data storage device; repeatedly measuring an electrical potential between one of the half cells and an environment-sensing half cell during a period of time to generate multiple data points indicative of the concentration of the first chemical species; and writing the data points to the data storage device. In the method of this aspect of the invention, the first chemical species and the second chemical species may be the same. The electrochemical sensor may further include a microprocessor or microcontroller in data communication with the data storage device, and the microprocessor or microcontroller may be powered by the electrical potential. The data storage device may include a volatile electronic memory device or a non-volatile electronic memory device; The volatile electronic memory device may be a dynamic random access memory (DRAM) or static random access memory (SRAM). The chemical species may be selected from the group consisting of: calcium, chloride, hydrogen, lithium, magnesium, potassium and sodium. The half cells may be connected by a conductive composition including a layer of material adapted for insertion into a depression of the sensor. The layer of material may be further adapted for removal from the depression, and may be a conductive gel adapted for absorbing a chemical species by diffusion. The sensor further may include at least one additional detector, the additional detector also being in contact with the data storage device. The additional detector may be adapted for detecting an environmental condition selected from the group consisting of: concentration of a chemical species, temperature, pressure, humidity, radiation, and light.

In a third aspect of the invention, there is provided a method of measuring and recording a concentration of a chemical species over time, including: providing an electrochemical sensor including an ion detector, a data storage device, and a microprocessor or microcontroller, wherein the ion detector includes a calibrant half cell having a first electrode and a reference half cell having a second electrode, with an ion-selective membrane disposed therebetween, each of the half cells including an ion composition, wherein the half cells are contacted by a conductive material, the conductive material including a preselected concentration of one or more chemical species, the conductive material further being in contact with a third electrode, wherein a first electrical potential exists between the first and second electrode, and wherein a second electrical potential exists between the second and third electrodes, and wherein the data storage device and the microprocessor or microcontroller are electrically connected to the detector and are powered thereby; and writing the second electrical potential to the data storage device.

Another aspect of the invention is an electrochemical sensor including an electrical circuit to read and store measurements of the sensor, wherein the sensor provides power to the electrical circuit.

### BRIEF DESCRIPTION OF THE DRAWINGS

FIG. 1 is a perspective view of one embodiment of a sensor.

FIG. 2 is a cross-sectional view of one embodiment of a sensor taken along line 2-2 of FIG. 1.

FIG. 3 is a cross-sectional view of one embodiment of a sensor taken along line 3-3 of FIG. 2.

FIG. 4 is a cross-sectional view of one embodiment of a sensor taken along line 4-4 of FIG. 2.

### DETAILED DESCRIPTION OF THE PREFERRED EMBODIMENT

The present invention combines electrochemical sensors with inexpensive microcircuitry and other optional sensing devices to produce an electrochemical sensor with microprocessor and memory capabilities. The sensor of the invention is small, self-powered, simple to use, and sufficiently inexpensive to be practical for use in recording environmental conditions to which low unit cost perishable products are exposed during shipping and/or storage.

Electrochemical sensors normally function to measure the presence of an ion or other chemical species. Non-limiting examples of ions and ionic groups are: bromide, calcium, chloride, fluoride, hydrogen, iodide, lithium, magnesium, potassium, sodium, ammonium, carbonate, hydroxide, phosphate, and sulfate. The actual quantitative measurement of the ion concentration is based on the fact that compositions of different ionic strength, if separated by a membrane, create an electrical potential across the membrane. Ion-selective membranes function by competitive displacement, wherein an ion of interest in a test composition displaces an ion from a ligand embedded within the membrane. The difference in ion concentration between the two compositions is quantitatively translated into an electrical potential that may be measured by an electrode, typically in units of millivolts (mV).

The present invention thus provides a sensor for real-time recording of environmental parameters. In one embodiment, the sensor of the invention includes at least one electrochemical detector for detecting ions or other chemical species, and also includes a data storage device and a microprocessor or microcontroller. As discussed below, during normal operations, the sensor continually monitors for preselected chemical species and uses its on-board microprocessor and data storage to record the results of these operations. The sensor also may optionally include one or more additional detectors, such as, for example, detectors of other chemical species or detectors of environmental conditions such as temperature, humidity, pressure, light, radiation, and the like.

The preferred electrochemical detector consists of two half-cells containing ion compositions of differing concentrations, with an ion-selective membrane disposed between the half cells. This type of detector is thus capable of precise quantitative detection of a chemical species. To the extent that the chemical species is itself either a cause or a by-product of harmful environmental conditions, the detector may function to indicate possible damage to a product being shipped or stored, by tracking the concentration of such a species over time.

Further, because the difference in ion concentration in the two half cells of the ion detector produces a voltage differential, the combination of half-cells can function as a battery. The detector thereby provides power to the microprocessor and the data storage device. The sensor of the invention thus combines detection functions and data recording functions, wherein the detector function actually supplies the power required by the recording function. The electrochemical detector is also capable of supplying power to any non-chemical detectors are also present on the sensor. Thus, the present invention provides an extremely versatile sensor concept that may be embodied in a vast number of forms, tailored to the particular environmental parameters that may be causative or indicative of possible damage to virtually any perishable product.

Determining the concentration of non-ionic chemical species may be achieved by detector embodiments of the invention, using the membranes and/or methods disclosed in co-pending U.S. patent application Ser. No. 09/055,815 filed Apr. 6, 1998, which is hereby incorporated by reference.

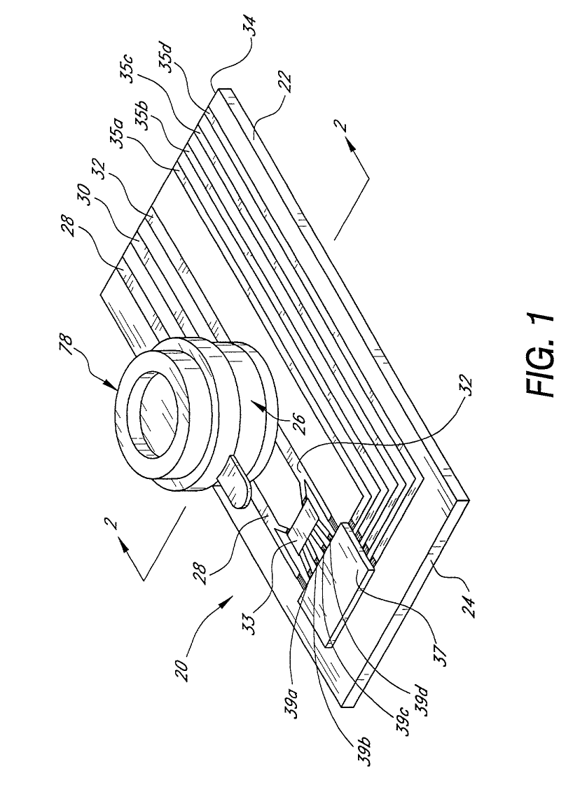

FIG. 1 is a perspective view of one embodiment of an electrochemical sensing device or sensor 20. This sensor device 20 includes an elongated, substantially flat, electrically non-conductive bottom board or plate 22 which serves several functions. Normally this board 22 may be either a common printed circuit board or a separate part formed by common injection molding techniques. It has a tab or tab-like end portion 24 which is intended to be used in manipulating the sensor device 20 as this device 20 is used. It also serves to support a cylindrical housing 26 which, together with the various parts located in and on the sensor device 20 forms the primary functional sensor unit (not separately numbered) of the entire sensor device 20.

The board 22 also serves to support three electrically conductive strips 28, 30 and 32 which extend alongside one another from an end 34 of the board 22 remote from the tab 24 to beneath the housing 26 where these strips 28, 30 and 32 are connected as subsequently described. As can be imagined, the end 34 preferably terminates in a series of electrical contacts for connecting the sensor 20 to a sensor data reader. The strips 28 and 32 also extend from beneath the housing 26 to provide electrical power to a data storage device 33 and a microprocessor 37.

The data storage device 33 can be virtually any well known general memory device such as a Random Access Memory (RAM). Preferably, the memory device should be able to store data for extended periods of time on a small amount of electrical energy. Data lines 39a-d connect the data storage device 33 and the microprocessor 37 so that instructions performed by the microprocessor 37 can result in data being transferred from the detector to the data storage device 33.

The microprocessor 37 can be any general purpose microprocessor, such as those made by Intel, Motorola, Toshiba or Texas Instruments. The microprocessor 37 preferably can be programmed to read data measurements from the detector and store those measurements to the data storage device 33. Embodiments of the microprocessor 37 include timer, date and time functions so that the microprocessor 37 reads data from the detector, for example, every hour and then stores the measured quantity to the data storage device 33 along with the date and time the measurement was taken.

Extending from the microprocessor 37 are a series of data lines 35a-d that run to the edge 34 of the board 22. The data lines 35a-d are used to transfer data from the data storage device 33 to the a sensor reader. The reader has an adapter that connects to the data lines 35a-d and accepts data output from the microprocessor 37. Thus, the microprocessor can run instructions that transfer data from the data storage device 33 to the reader.

It should be understood that other components such as capacitors, oscillators, resistors and the like may be necessary for the microprocessor 37 to read and store data to the data storage device 33. However, it is well within the ordinary skill of one in the art to use these components in order to link a microprocessor to a data storage device.

The strips 28, 30 and 32 and data lines 35a-d and 39a-d can be formed as any other conductors on a printed circuit board or can be formed from a conventional electrically conductive adhesive polymer composition. Preferably they are sufficiently abrasion resistant so that they can be used as prongs on a common electrical plug to connect the entire sensor device 20 to an appropriate electronic device (not shown) or used with the sensor device 20 to make measurements, determinations or analyses using the sensor device 20.

Since the present invention is not concerned with such an electronic device and since suitable electronic apparatus for use with the sensor device 20 is known, no effort is made to describe such an appropriate electronic device in this document. Although the strips 28, 30 and 32 and data lines 35a-d can be connected to such an electronic device using conventional means (not shown) such as common wires and spring biased conductive clips it is preferred to make the board 22 sufficiently stiff so that a user, by holding the tab 24, can insert a portion 36 of the board 22 located between the housing 26 and the end 34 into an appropriate, conventional female socket (not shown) on such an electronic device. As a result of this the portion 36 of the board 22 can be referred to as a connector or male connector.

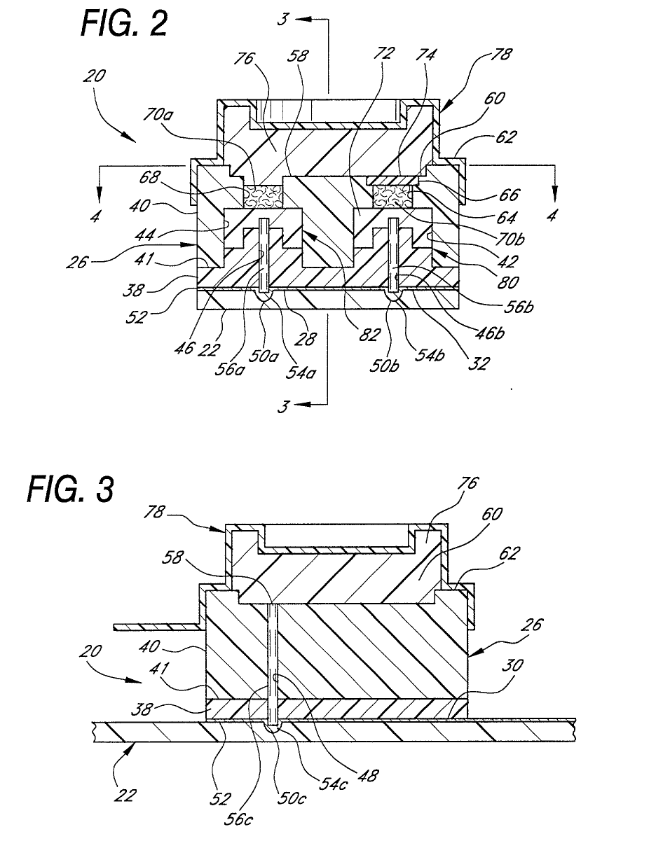

As indicated in FIG. 2, the housing 26 in the device 20 is essentially a small, short cylinder. As manufactured, the housing 26 is formed of two separate electrically non-conductive components—a base 38 and a top 40—which are shaped as subsequently described. The components 38 and 40 can be easily formed from common polymers by conventional injection molding techniques. As formed they have adjacent surfaces 41 which are normally secured together by any convenient means such as ultrasonic welding or the use or an inert adhesive (not shown). These parts 38 and 40 are shaped so that as they are secured together along their surfaces 41, they define within the housing 26 two separate internal cavities 42 and 44.

The base 38 is shaped so as to include elongated, vertically extending passages 46a,b extending into each of the cavities 42 and 44. As indicated in FIG. 3, both the base 38 and the top 40 are shaped so as to include a third elongated, vertically extending passage 48. The passages 46a,b and 48 are located so as to be immediately above small depressions 50a,b,c in the board 22. Except where the depressions 50a,b,c are located, the base 38 is attached directly to the board 22 so as to overlie the strips 28, 30 and 32 through the use of a small layer 52 of a conventional electrically nonconductive adhesive. Various functional equivalent techniques such as ultrasonic welding can also be used to secure the housing 26 in place on the board 22.

The depressions 50a,b,c intersect the strips 28, 30 and 32; they are used to hold small bodies 54a,b,c of a conventional electrically conductive polymer composition so as to electrically connect the strips 28, 30 and 32 to individual electrodes 56a,b,c located in each of the passages 46a,b and 48. Other equivalent manners of establishing electrical connection between these parts can, of course, be employed. These electrodes 56a,b,c can be press-fitted in place or can be secured in position through the use of a conventional adhesive (not shown).

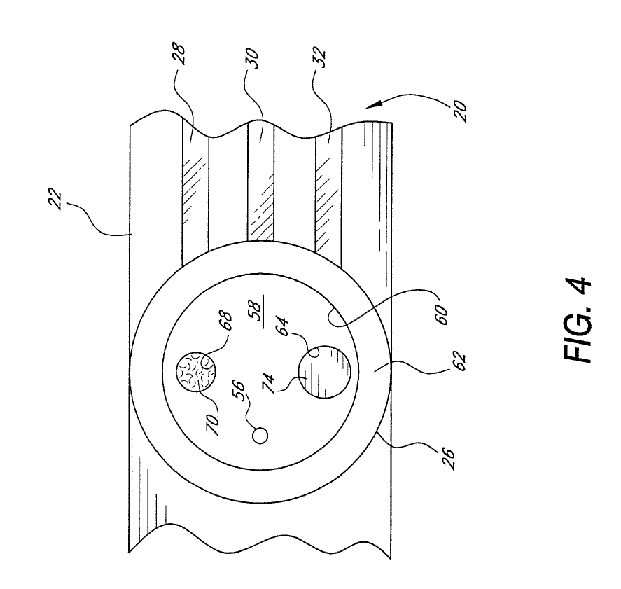

When they are secured in place, the electrodes 56a,b in the passages 46a,b extend upwardly into the cavities 42 and 44 while the electrode 56c extends through the passage 48 extends so as to be exposed to the bottom 58 of an enlarged, flat, disc-like depression 60 in the upper surface 62 of the top 40. Because of the shape and configuration of this depression 60 it may be regarded as a sample container or sample receptacle. This can be seen more clearly in reference to FIG. 4.

Referring back to FIGS. 1 and 2, a stepped hole 64 having an upwardly facing shoulder 66 is located in the top 40 so as to lead downwardly from the depression 60 into the cavity 42. Another hole 68 is located in the top 40 so as to lead downwardly from the depression 60 into the cavity 44. The hole 64 below the shoulder 66 and the hole 68 are both filled with identical porous, electrically non-conductive plugs 70a,b. These plugs 70a,b may be considered as flow restricting members or membranes. They may be press-fitted into place or may be secured in position through the use of an appropriate conventional adhesive (not shown). Both of these plugs 70a,b and the cavities 44 and 42, respectively beneath them are filled with an electrolyte composition 72 as indicated in the ensuing text. In addition, a small, comparatively thin membrane or barrier 74 as later discussed in this document is secured in place in a similar manner in the hole 64 against the shoulder 66.

The composition of the membrane 74 is quite important in connection with the sensor or sensing device 20. When this sensor 20 is to be used in detecting a specific ion species, this membrane 74 should be selective relative to such ion. Similarly if the sensor 20 is to be used in detecting and measuring two or more closely related ions the membrane should be selective in connection with all of such ions. Non-limiting examples of some ions that can be selected using an ion selective membrane are: bromide, calcium, chloride, fluoride, hydrogen, iodide, lithium, magnesium, potassium, sodium, ammonium, carbonate, hydroxide, phosphate, and sulfate.

The term selective as used in this discussion means that the material in the membrane 74 should be of a character which is such that it can be used in accordance with conventional prior art electrochemical practice so as to detect the presence or absence of an ion or such related ions in a fluid and, if such an ion or such ions are present, so as to provide an indication of the amount of such ions present in the sample.

Similarly, if the sensor 20 is to be used to detect the presence of a gas or related gases in a sample and, if such a gas or gases are present, to provide an indication of the extent of such presence the membrane 74 should be of a type recognized by the prior art as effective for such purpose. Because of the fact that suitable compositions for use with ions and gases are known and because of the fact that the present invention does not pertain to the use of any specific membrane or barrier material it is not considered necessary or desirable to further discuss suitable membranes 74.

For the same reason it is not considered necessary to encumber this specification with a detailed discussion of suitable electrolytes or electrolyte compositions for use as an electrolyte composition 72 as indicated in the preceding. While the present invention expressly contemplates both liquid and gelled electrolyte compositions, the gelled composition is preferred. This is because of the fact that a liquid may flow out of any of the locations discussed during packaging, handling and use of a sensor 20 whereas a gelled electrolyte under the conditions to which a sensor 20 will be subjected will not normally flow from any location in which it is located. It is considered that gelled ion and gas selective electrolytes are well known. Hence, it is not considered necessary to discuss them in detail in this specification. Normally they will be prepared by adding a suitable gelling agent such a polyacrylamide or other known polymer composition which will cross-link on gelling to a liquid electrolyte and then placing the electrolyte in a desired final location before the gelling agent causes a gel to form.

With the sensor or sensing device the cavities 42 and 44 and the plugs 70a,b can be filled concurrently by vacuum impregnation with the composition 72 before it has gelled prior to the membrane 74 being located in its final position. Then, after the membrane 74 has been located in place, by casting some of the same or similar composition 72 in the depression 60 so as to create the sample-receiving composition 76. It will be recognized that there can be considerable variation in both the composition of the electrolyte used as the composition 72 and in forming the sample-receiving composition 76.

As supplied to a user the device preferably includes a small impervious, polymer protective cover or cap 78 which fits tightly against the top 40 so as to close or seal off the sample-receiving composition 76 from ambient influences. Although this cap 78 can be held in place merely by fitting tightly against the housing 26 it can also be held in place by a conventional tacky adhesive (not shown) or by a small, easily broken weld or seal (not shown).

As the sensor device 20 is used, the depression 60 containing the sample-receiving composition 76. Removal of the cap 78 exposes the sample-receiving composition 76, which will tend to absorb chemical species from the ambient environment. Preferred sample-receiving compositions are adapted to absorb the chemical species of interest by diffusion, and also to minimize water loss from the composition. The absorbed chemical species thus change the overall concentrations of chemical species within the composition of the sample-receiving composition 76, which is, throughout this time, in direct contact with the membrane 74, one of the plugs 70a and the electrode 56. The plug 70a associated with the cavity 44 will tend to isolate the sample-receiving composition 76 from the electrolyte composition 72 within the cavity 44. Although to a degree the plug 70b associated with the other cavity 42 does this, it primarily serves to reinforce or support the membrane 74 while concurrently isolating such liquid.

As a consequence of the support provided by the plug 70b, the membrane 74 can be comparatively thin and/or weak without there being significant danger of it being cracked or otherwise damaged. This is important for economic reasons, since it makes it possible to minimize the material in the membrane 70. It can also be desirable for other reasons. The sample-receiving composition 76 in effect bridges the cavities 42 and 44 in a manner which is related to the manner in which a conventional bridge used in prior electrochemical measurements extends between and connects two separate half cells.

In the sensor device 20, the cylindrical housing 26 acts as a common housing for two such half cells 80, 82 (FIG. 2). The half cell 80 includes the portions of the housing 26 surrounding the cavity 42, the electrode 56b extending into this cavity 42, the electrolyte composition 72 within it, the plug 70b associated with it and the membrane 74. This half cell 80 may be referred to as a sensing cell because the membrane 74 makes it possible to use this sensing half cell 80 to provide a signal indicative of the presence or absence of an ion or ions or a gas or gases in the specimen and if appropriate an indication of the quantity of the same present. Non-limiting examples of gases to be detected are ammonia, carbon dioxide, carbon monoxide, ethylene, methane, nitrogen, oxygen, and ozone.

The second half cell 82 includes the portions of the housing 26 surrounding the cavity 44, the electrode 56a extending into this cavity 44, the electrolyte composition 72 within this cavity 44 and the plug 70a associated with it. This second half cell 82 can be referred to as a calibrant cell because it is used to provide a calibration reading or signal in accordance with conventional practice. The sample-receiving composition 76 thus may be quantitatively analyzed for the ion(s) or other chemical species of choice, and the response in mV is converted to indicate the concentration thereof.

The data storage device 33 may have a volatile memory or a non-volatile memory. However, the most advantageous memory devices can efficiently store data over the extended period of time that the sensor is in use.

If a volatile memory device is chosen, single use of the sensor can be assured by providing a function in the sensor data reader that erases or otherwise degrades or destroys the data stored in the data storage device 33 while the sensor is in the sensor data reader. If the volatile memory device loses power, all of the data stored will be lost. Suitable memory devices for use in this embodiment of the invention include, for example, dynamic RAM and static column RAM. In this embodiment, the energy required to refresh the volatile memory device is provided by the electrical potential existing between the calibrant half cell 82 and the sensing half cell 80.

Energy demands of preferred memory devices and microprocessors are normally so small that the nature of the calibrant medium would not be significantly changed even over several years of storage of the sensor. Thus, the calibration means of the sensor can effectively function as a battery to maintain the data on a volatile data storage device 33 and to power a microprocessor.

### Using the Sensor Device

When the sensor 20 as supplied to a user is to be employed, it is necessary to perform a series of minor steps in order to prepare it for use. The sequence of these steps may be varied depending on the particular features of the sensor, as dictated by the characteristics of the goods to be shipped or stored with the sensor. The sensor device 20 may be initiated by removing the cover or cap 78 from the housing 26, by simply lifting or tearing it off from the housing 26. Removal of the cover 78 exposes the sample-receiving composition 76 to the ambient environmental conditions, and the chemical species of interest may begin to diffuse into the sample-receiving composition 76.

At this point the device or sensor 20 is ready to be placed into a container housing the perishable product to be shipped or stored. The concentration of the chemical species of interest in the sample-receiving composition 76 may be detected constantly or at pre-selected time intervals, by recording the electrical potential between the sensing electrode 56b and the sample electrode 56c to the data storage device 33. The sample receptacle 60 or half cell contacted by the sample electrode 56c may also be referred to as the environment-sensing half cell.

These voltage measurements may be converted to chemical species concentration data based on the relationship between the known concentration of the species in the calibrant half cell 82 and the measured voltage between the calibrant half cell 82 and the reference half cell 80. The data points indicative of the concentration of the chemical species in the sample-receiving composition 76 thus constitute a real time recording of this particular environmental parameter from the time the cover is removed to the time the sensor 20 is removed from the product container and inserted into a reader.

Throughout the life of the sensor 20 of this embodiment, the microprocessor 37 processes data relating to the electrical potential between the sample electrode 56c and the sensing electrode 56b. This data is stored to the data storage device 33 periodically. Unless otherwise initiated, the recording process begins immediately after manufacture of the sensor. In some case, the data sampling process begins even prior to the use of the sensor. Thus, it is possible that significant amounts of unimportant information may be recorded prior to use. Thus it is preferable to program the microprocessor to ignore or compress multiple data points that reflect no change in the measured electrical potential, and to specifically identify, for example, the date, duration, and magnitude of any changes in the potential that do occur.

In another embodiment, the sensor is made without a sample-receiving composition 76 in place. Instead, the depression 60 is initially empty, and there is thus no conductive contact between the calibrant half cell 82 and the sensing half cell 80. As a result of the absence of contact, there is no power supplied to the data storage device 33 or to the microprocessor 37. The sensor 20 of this embodiment in initiated when the user inserts a disc of sample-receiving composition 76 into the depression 60. This establishes contact between the calibrant half cell 82 and the sensing half cell 80, supplying power to the data storage device 33 and the microprocessor 37. Thus, the insertion of the disc of conductive sample-receiving composition 76 both turns on the power and recording function of the sensor 20, and also places the sample-receiving composition 76 in proper position for absorbing the chemical species of interest, allowing the sensor 20 to record any changes in the concentration thereof over time. In this embodiment, there are no data recorded until the sensor 20 is initiated by the user, and thus there is no need for the microprocessor 37 to ignore or compress multiple identical data points that otherwise would be recorded prior to use of the sensor.

The sensor of the invention may optionally include any number of other detectors (not shown), whether of chemical or physical properties, which may all be powered by the electrochemical detector, and which may all deliver data to the same or separate data storage devices, under control of one or many microprocessors. For example, a sensor to provide quality control for a shipment of frozen fish may include a sensitive detector of ammonium ions, as well as a thermocouple and a humidity sensor, to detect ammonia emitted by spoiling fish, as well as to track the temperature at which the shipment was maintained, and any changes in humidity that may reflect a thawing event. As another example, a shipment of bananas, intended to be shipped under nitrogen to prevent premature ripening, may employ a sensor with nitrogen and ethylene detectors, to assure that the bananas had sufficient nitrogen and minimal accumulations of ethylene (a gaseous fruit-ripening hormone) throughout the course of transit.

Single use of the sensor 20 may be encouraged by the mere fact that the species concentrations within the sample-receiving composition 76 may be altered during use, and also because of the low cost of the sensor 20 itself. In addition, the microprocessor 37 on the sensor 20 may be programmed to deliver data to the sensor data reader only once, and then lock out any further functions or procedures. Likewise, the sensor data reader may be programmed to signal the microprocessor 37 to stop performing certain functions.

In some embodiments of the invention, multiple use of the sensor 20 may be desired. In such embodiments, the disc of sample-receiving composition 76 is constructed with a tab (not shown) or other member for facilitating removal of the disc 76 from the sensor data reader. After a first use of the sensor 20, the disc 76 is removed and discarded,. The electrical circuit supplying power to the data storage device 33 and the microprocessor 37 is thus broken. If the data storage device 33 is a volatile memory device, the loss of power clears the accumulated data from the volatile memory device. Reuse is initiated by placing a new disc of sample-receiving composition 76 into the depression 60, which restores power to the electronic components 33, 37 of the sensor 20.

Upon delivery of the perishable goods, or upon their removal from storage, the user may withdraw the sensor 20 from among the goods and download the information it has recorded for determination of whether the goods may be been damaged during shipment of storage. The sensor 20 is inserted into a sensor data reader, which receives the data from the sensor 20 and produces a report. There are many ways in which the data may be processed, either by the microprocessor 37 on the sensor 20, or by the reader, or both. The critical information to be received from the sensor 20 will depend on the nature of the perishable goods to which it was exposed. Thus, the user may wish to note only the range of a given measured environmental parameter, the duration of a particular kind of extreme, whether two potentially harmful conditions occurred at the same time, and the like. The microprocessor 37 on the sensor 20 or the sensor data reader may be easily programmed to deliver the kind of report that would be appropriate for the type of gods shipped or stored.

### Equivalents

While the foregoing Detailed Description and Examples disclose preferred embodiments of the invention, the invention also contemplates numerous other embodiments. The invention is thus to be limited only by the scope of the following claims.

What is claimed is:

1. A sensor for detecting and recording an environmental condition, comprising:
a first half cell comprising a calibrant composition having a first ion species at a first ion concentration, and a first electrode in contact with the calibrant composition;
a second half cell comprising a sensing composition for sensing said first ion species, comprising a second ion concentration of said first ion species, and a second electrode in contact with the sensing composition;
an ion-selective membrane disposed between the first half cell and the second half cell;
a conductive composition in contact with the first half cell and the second half cell so that an electrical potential is formed across the ion selective membrane; and
a data storage device and a microprocessor in data communication with the first electrode and the second electrode, wherein the electrical potential provides power to the data storage device and to the microprocessor.

2. The sensor of claim 1, wherein the data storage device comprises a volatile electronic memory device or a non-volatile electronic memory device.

3. The sensor of claim 2, wherein the volatile electronic memory device is a dynamic random access memory (DRAM) or static random access memory (SRAM).

4. The sensor of claim 1, wherein the first ion species is selected from the group consisting of: calcium, chloride, hydrogen, lithium, magnesium, potassium and sodium.

5. The sensor of claim 1, further comprising a third half cell comprising a second calibrant composition of a second ion species, and a third electrode in contact with the second calibrant composition.

6. The sensor of claim 5, wherein the second ion species is selected from the group consisting of: calcium, chloride, hydrogen, lithium, magnesium, potassium and sodium.

7. The sensor of claim 1, wherein the conductive composition comprises a layer of material adapted for insertion into a depression of the sensor to contact the first and second half cells to form the electrical potential across the membrane.

8. The sensor of claim 7, wherein the layer of the material is further adapted for removal from the depression.

9. The sensor of claim 8, wherein the layer of material is a conductive gel adapted for absorbing a chemical species by diffusion.

10. The sensor of claim 1, further comprising at least one additional detector, the additional detector also being in contact with the data storage device and the microprocessor.

11. The sensor of claim 1, wherein the additional detector is adapted for detecting an environmental condition selected from the group consisting of: concentration of a chemical species, temperature, pressure, humidity, radiation, and light.

12. A method of measuring and recording a concentration of a first chemical species over time, comprising:
providing an electrochemical sensor comprising an ion detector and a data storage device, wherein the ion detector comprises at least two half cells having an electrical potential therebetween, wherein the electrical potential is indicative of a concentration of a second chemical species in at least one half cell, and wherein the electrical potential provides power to the data storage device;
repeatedly measuring an electrical potential between one of the half cells and an environment-sensing half cell during a period of time to generate multiple data points indicative of the concentration of the first chemical species; and
writing the data points to the data storage device.

13. The method of claim 12, wherein the first chemical species and the second chemical species are the same.

14. The method of claim 12, wherein the electrochemical sensor further comprises a microprocessor in data communication with the data storage device, and wherein the microprocessor is powered by the electrical potential.

15. The method of claim 12, wherein the data storage device comprises a volatile electronic memory device or a non-volatile electronic memory device.

16. The method of claim 15, wherein the volatile electronic memory device is a dynamic random access memory (DRAM) or static random access memory (SRAM).

17. The method of claim 12, wherein the chemical species is selected from the group consisting of: calcium, chloride, hydrogen, lithium, magnesium, potassium and sodium.

18. The method of claim 12, wherein the half cells are connected by a conductive composition comprising a layer of material adapted for insertion into a depression of the sensor.

19. The method of claim 18, wherein the layer of the material is further adapted for removal from the depression.

20. The method of claim 18, wherein the layer of material is a conductive gel adapted for absorbing a chemical species by diffusion.

21. The method of claim 12, wherein the sensor further comprises at least one additional detector, the additional detector also being in contact with the data storage device.

22. The method of claim 21, wherein the additional detector is adapted for detecting an environmental condition selected from the group consisting of: concentration of a chemical species, temperature, pressure, humidity, radiation, and light.

23. A method of measuring and recording a concentration of a chemical species over time, comprising:
providing an electrochemical sensor comprising an ion detector, a data storage device, and a microprocessor, wherein the ion detector comprises a calibrant half cell having a first electrode and a reference half cell having a second electrode, with an ion-selective membrane disposed therebetween, each of the half cells comprising an ion composition, wherein the half cells are contacted by a conductive material, the conductive material comprising a preselected concentration of one or more chemical species, the conductive material further being in contact with a third electrode, wherein a first electrical potential exists between the first and second electrode, and wherein a second electrical potential exists between the second and third electrodes, and wherein the data storage device and the microprocessor are electrically connected to the detector and are powered thereby; and
writing the second electrical potential to the data storage device.

24. An electrochemical sensor comprising an electrical circuit to read and store measurements of the sensor, wherein the sensor provides power to the electrical circuit.
